(19) United States
(12) Patent Application Publication
(10) Pub. No.: US 2002/0002888 A1
(43) Pub. Date: Jan. 10, 2002

(54) Cord cutting device and method which operates without relative speed between the cutting means and the cord

(75) Inventor: Olivier Essinger, Chatel-St-Denis (CH)

Correspondence Address: BAKER BOTTS L.L.P., 44TH FLOOR, 30 ROCKEFELLER PLAZA, NEW YORK, NY, 10112-4498, US

(73) Assignee: SEDEPRO

(21) Appl. No.: 09/837,521

(22) Filed: Apr. 18, 2001

(30) Foreign Application Priority Data
Apr. 18, 2000 (FR) 00/05072

(51) Int. Cl. B26D 1/56; B26D 1/00

(52) U.S. Cl. 83/13; 83/346

(57) ABSTRACT

A cutting device and method for a tire reinforcement cord, the cutting device including a knife mounted on the periphery of a first rotary disk, and a second rotary disk mounted opposite the first rotary disk, and in which the knife of the first disk and the second disk are brought into cutting contact with the reinforcement while driving the first and second disks in rotation, the cutting device being preset so that, on cutting, the knife engages with said reinforcement, while the peripheral speed of said first and second rotary disks is close to the linear speed of the reinforcement.

### BACKGROUND OF THE INVENTION

The present invention concerns the manufacture of tires. More precisely, it relates to the manufacture of reinforcements, particularly, for the tire crown.

It is known that tires are usually reinforced by monofilaments or cables or other assemblages of unitary strands, which will be generically designated by the term “reinforcement” herein. An important architecture parameter is the angle formed by those reinforcements in relation to a standardized reference well known to the experts, namely, the median plane perpendicular to the axis of rotation of the tire. This pertains, particularly, to reinforcements at zero degree, whatever the exact location of those reinforcements in the tire. The reinforcements can be made by depositing a single cord individually or by depositing several cords simultaneously, for example, a dozen parallel cords. The term “cord” refers without distinction to a single strand like a monofilament or to an assemblage of unitary strands like a cable, and the term “reinforcement” refers without distinction to a single cord or a group of parallel cords. The cords can be bare or pre-coated with rubber or any other material capable of rendering the cords adhesive.

The state of the art contains numerous examples of use of zero degree reinforcements for reinforcing the sidewalls or the crown of tires. But such an arrangement has the major disadvantage that the tire blank in production no longer lends itself or lends itself poorly to shaping during the subsequent phases of tire manufacture.

In order to provide a solution to these problems of shaping, a well known technique consists of cutting the cords at zero degree into sections. It is appropriate to call the piece of cord lying between the cuts a “section”. U.S. Pat. No. 4,791,973 illustrates this technique. A tire containing a belt including zero degree cords is described there. The latter are not circumferentially continuous. A number of sections succeed one another along a perimeter.

As it is very difficult to cut a reinforcement in rapid procession at very high speeds, this principle leads to rates of laying zero degree reinforcements that are much too slow, particularly if only one cord at a time is deposited and not a group of parallel cords, winding the reinforcement on the blank being made while moving a reinforcement laying head transversely. If depositing a single ply is envisaged, for example, by winding said ply in one turn on the bare blank during its assembly, it is necessary to prepare the desired incisions on said ply in advance, and that method requires providing a welding overlap in order to ensure the recovery of circumferential tensile stresses.

### SUMMARY OF THE INVENTION

The object of the invention is to propose very rapid cutting means, whether these cuts are frequent, as in the case described above, or cutting takes place only at the end of the tire operation, as in the case of zero degree filament yam reinforcements. The invention makes it possible to envisage, under good conditions of industrial performance, the laying of cord sections for any reinforcement application at all.

The invention proposes a tire reinforcement feed and cutting device, containing:

a reinforcement distributor;

a cutting device comprising a knife mounted on the periphery of a first rotary disk, and comprising a second rotary disk mounted opposite the first rotary disk;

means for bringing the knife of the first disk and second disk in contact with the reinforcement by rotation of the disks, the cutting device being preset so that, on cutting, the knife can be actuated to engage with said reinforcement, when the peripheral speed of the first and second rotary disks is close to the linear speed of the reinforcement.

The invention makes direct fabrication possible on a support from spools in which the reinforcement is continuously withdrawn. The support in question can be a revolving form on which a crown block is fabricated, or a drum supporting the raw tire in the course of manufacture, or any other suitable support, the invention not dealing per se with that aspect. For the reinforcement laid to remain in place on the support, it is advantageous for the support to be coated with a layer of raw rubber to which the reinforcement can adhere, or into which the reinforcement can penetrate at least slightly as it is brought on the support.

The invention thus offers a method of manufacture of a tire reinforcement, comprising the following steps:

presenting a reinforcement laying head opposite a predetermined starting point on a fabrication support and making the cutoff end of said reinforcement advance and adhere to the support at the starting point;

driving the support in rotation in order to wind the reinforcement on the support, while synchronizing the relative displacement of the laying head on the support in order to sweep the surface of the support which is to be covered by the reinforcement;

actuating reinforcement cutting means capable of cutting the reinforcement without stopping the advance of the reinforcement, at a given time, so that the continuation of rotation of the support brings the final end of the reinforcement to a predetermined stopping point for the reinforcement.

### DESCRIPTION OF THE DRAWINGS

The invention will be better understood from the description to follow, given nonlimitatively with reference to the attached drawings in which:

FIG. 1 is a schematic view showing the main parts used for laying a zero degree reinforcement;

FIG. 2 is a more detailed view of a cutting device according to the invention;

FIGS. 3a, 3b and 3c show the device of FIG. 2 in three successive stages of cutting; and

FIG. 4 is a more detailed view of a variant embodiment of a cutting device according to the invention.

### DESCRIPTION OF PREFERRED EMBODIMENTS

FIG. 1 shows a support 1 on which a reinforcement is fabricated. That support could be any type of form defining the surface on which the cord sections constituting the reinforcement are to be placed, like, for example, an inflatable reinforced diaphragm, or a diameter-adjustable form of the type used in machines for fabricating crown blocks, requiring a purely cylindrical profile, or a transversely curved form. The support 1 is pre-coated with all the constituents it must receive before addition of the zero degree reinforcement. The support 1 is driven in rotation in the direction indicated by arrow A.

A reinforcement distributor 2 is shown, adapted specifically for delivering a single cord 3, without that being interpreted as limiting the scope of the invention, which extends to any type of reinforcement. The cord 3 is unwound from a spool (not shown). The cord 3 is engaged on different pulleys of a guide system 32 enabling it, from a point fixed in space (pulley 33), to join a laying head 34 movable in space. A robot 35 with three axes (Y, Z, α) makes it possible to ensure the correct presentation of the cord 3 anywhere on the surface of the support 1, even when the support is not cylindrical.

The cord 3 is inserted in a cutting device 9, installed on the laying head 34. Just like the cord distributor, the cutting device 9 is in this example adapted to a reinforcement consisting of a single cord. Below the cutting device 9, preferably, an application roller 5 presses the cord 3 against the support 1 in order to make it slightly penetrate the rubber with which the support 1 is coated in order to keep the cord 3 on the support 1 as laying progresses. The application roller 5 is represented fixed on the attached drawing, although it can be mounted spring-urged in a radial direction relative to the support.

The cutting device is shown in greater detail in FIG. 2. The cutting device 9 comprises a knife 92 mounted on the periphery of a first rotary disk 91 and an anvil 93 mounted on the periphery of a second rotary disk 90 which, in twin, is mounted opposite the first rotary disk 91. The second disk 90 has a radial cut-out 94 extended by a circumferential cut-out 95 passing under the anvil 93 in order to provide the anvil 93 with some elasticity, which makes it possible to limit the bearing loads of the knife 92 on the anvil 93.

Above the cutting device 9, the cord 3 is inserted in a sheath 40 (see FIG. 2). Below the cutting device 9, the cord 3 is inserted in a sheath 41. A compressed air supply can optionally facilitate the feed of the cord 3 into the sheaths 40 and 41. It may be desired, for example, to lay textile cords. All cords having too low a compressive strength, notably, for textile cords, should preferably be kept very taut with outside assistance like that which can be provided by an air flow in the direction of feed of the cord. For example, pneumatic propulsion of the kind shown by the reference “56” in U.S. Pat. No. 3,894,906 can be used.

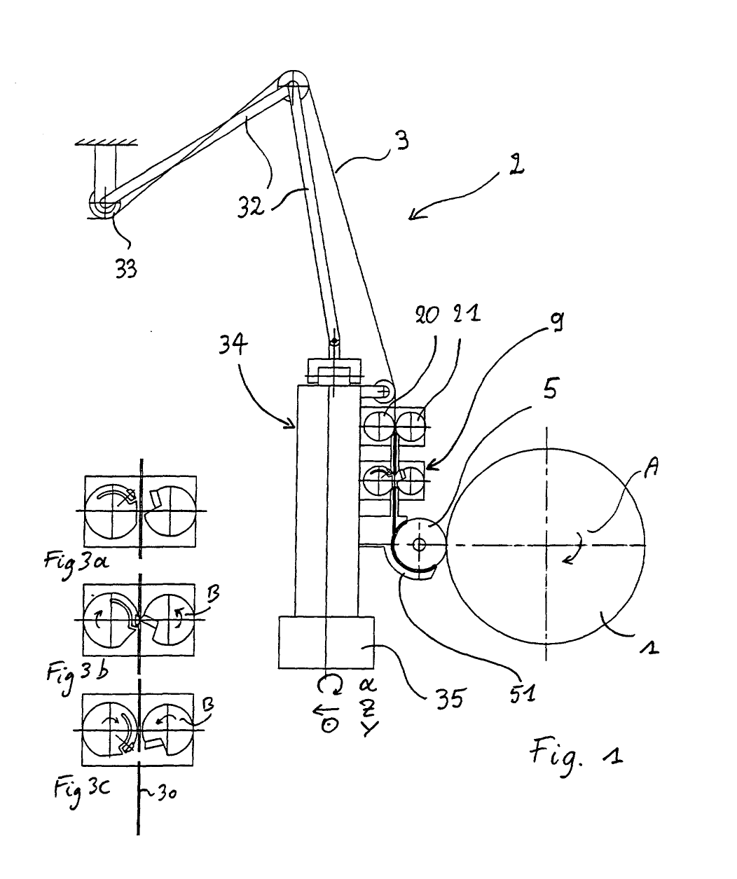

Outside of the cutting phases, the cord 3 passes between the first and second rotary disks 90, 91 (see configuration represented in FIG. 2). After an order to cut, the automatic control of the cutting device 9 causes synchronous acceleration of the first and second disks 90 and 91 in the direction indicated by the arrows B drawn in the center of each of the disks (see FIGS. 2, 3b, 3c). The cutting device is preset and the control is thus programmed so that, at the time the knife 92 of the first disk 91 and the anvil 93 of the second disk 90 come in contact with the cord 3 (in order to make a cut), the peripheral speed of the first and second rotary disks (more precisely, the peripheral speed of the radial end of the knife 92 and the radial end of the anvil 93) is close to the linear speed of the reinforcement. The knife 92 and the anvil 93 act on the cord 3 roughly or even exactly without relative longitudinal sliding between the cord 3 and the knife 92 and anvil 93.

The cut being made, the automatic control of the cutting device 9 produces deceleration of the first and second disks 90 and 91. Of course, unless it is deliberately intended to arrange a new cut, it is indispensable to brake the knife until stopping on less than one turn. The cutting device is then set for the following cut, which consists of bringing the knife 92 back to the standby position displayed in FIG. 2 or FIG. 3a. That can be done in two ways: with or without reversing. For example, rotation of the disks 90 and 91 continues until they come into the configuration of FIG. 3a, that is, their standby position in the example described. Or stopping is accomplished beyond the standby position and the disks 90 and 91 are brought back to their standby position. Or the disks 90 and 91 are even brought back to their standby position by going through the cutting position (FIG. 3b) again, but not without having released the knife 92 and anvil 93 assembly by a movement perpendicular to the plane of the different figures.

The invention illustrated here shows a continuous winding of a great length of cord 3 in order to form a continuous cord reinforcement, cutting taking place only at the end of laying the reinforcement. The pull of cord 3 out of a spool (not represented) is produced by rotation of the support itself. It is again necessary for the end of the cord to be engaged on the support 1 for rotation of the support 1 to be able to advance the cord 3. After cutting, the new end of the cord is not yet engaged on the support 1. In general, the inertia of the cord is insufficient for the new end to be able to join the support for manufacture of the following tire, and such a method would in any case be too imprecise. Hence, the use of a system of positive feed of the cord 3.

Means are therefore now described for imparting a predetermined advance motion to the reinforcement, after a cut, in the longitudinal direction of the reinforcement.

This is the function of the rollers 20 and 21 in the first variant illustrated in FIG. 1. The cord 3 is therefore preferably driven by two rollers 20, 21 situated above the cutting device 9. The cord 3 is gripped between the rollers 20 and 21 on demand by a gear system not represented. One of the rollers 20 or 21 is driven by a cord 3 feed motor (not shown). Of course, as has become standard, the feed motor can contain a coder or a resolver. It is thus possible to impart a very precise linear feed (or backward motion) to the cord 3, while constantly knowing the exact metering of the quantity of cord 3 propelled down (or brought back up). Due to this motor drive system, installed above the cutting device 9, it is possible to advance the end of the cord 3 created by a cut to the support 1, possibly with pneumatic assistance, as mentioned above.

Once the cord 3 is on the support 1, the motor drive function can be disengaged from the rollers 20 and 21. On the other hand, the unwinding control function of cord 3 pulled by the support 1 retains all its usefulness.

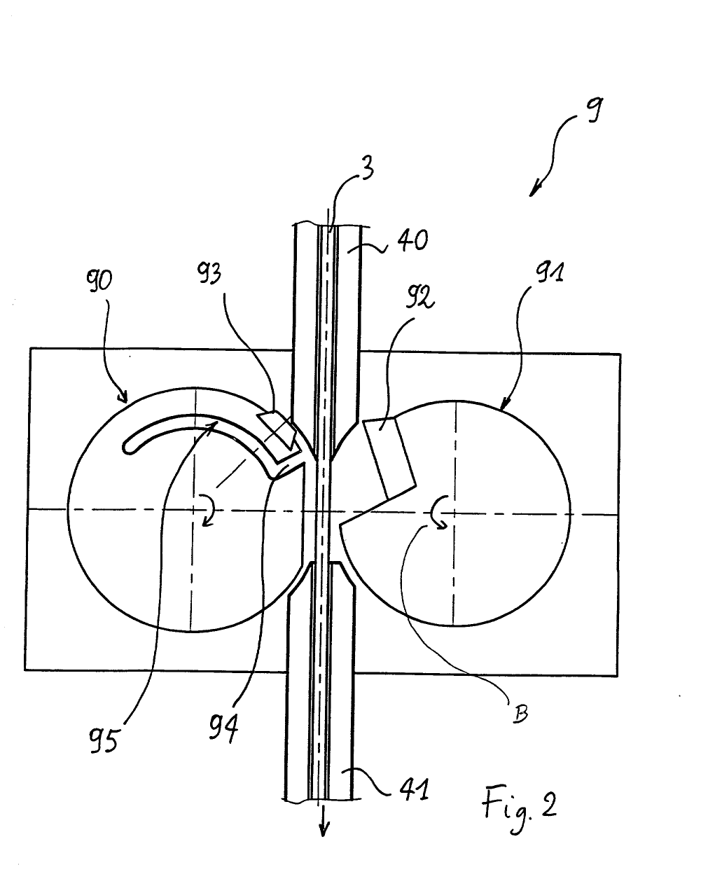

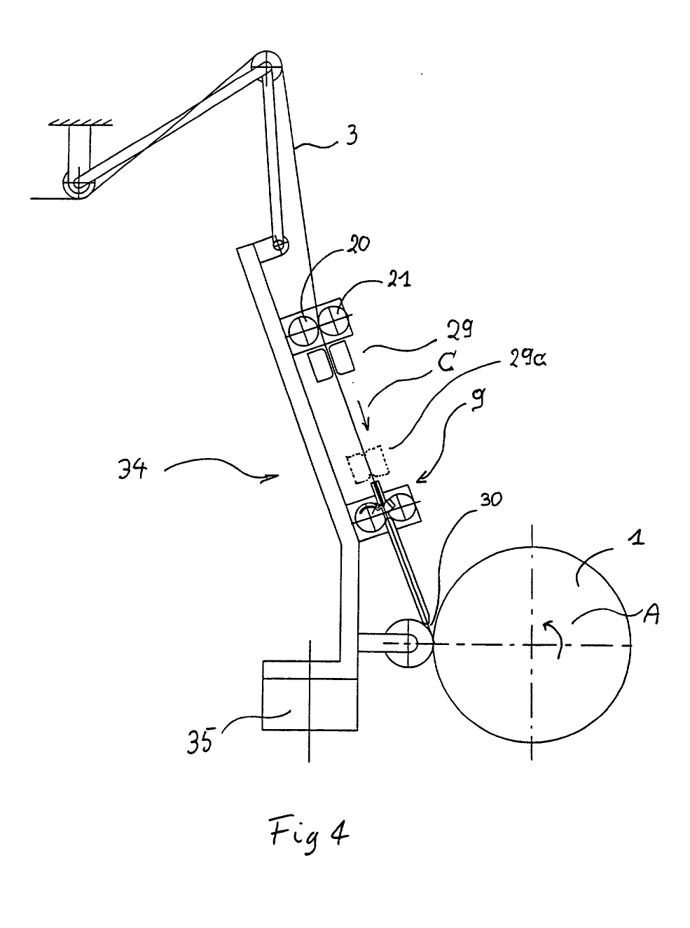

After cutting, the section 30 of cord 3 released by cutting (see FIG. 4) can no longer benefit from being driven by the rollers 20 and 21 installed above the cutting device 9. That is why it is desirable for the length of the shortest section 30 released by cutting by the machine described to be at least slightly greater than the space between the cutoff point and the laying point, so that the end of the cord 3 rejoins the laying point on the support 1 just before the cord 3 is cut. Let us point out that if the kinetic energy accumulated by the sections is sufficient, it is possible to ensure the operation of the machine described, even if the sections are shorter in length than the minimum mentioned above. After cutting, the section 30 of cord 3 released by cutting continues to be driven by the movement of the support 1 to which it adheres.

Of course, means of application are provided, receiving the reinforcement below the cutoff point and channeling it to a reinforcement laying point on a manufacturing support. The sheath 41 participates in guiding the cord 3. In the first variant, the cord 3 is laid on the support 1 after turning around by winding over approximately half the periphery of an application roller 5, which presses the cord 3 against the support 1 to make it slightly penetrate the rubber with which the support 1 is coated. On its course to the support, the cord 3 encounters a guide 51, which ensures its winding around the roller 5 and guarantees maintenance in correct position.

The variant of FIG. 4 is distinguished from what has just been described by the fact that laying of the cord 3 on the support is directly tangential. That means it is done without turning around the reinforcement. Furthermore, control of the cord 3 above the cutting device 9 is ensured by a simple clamp 29 capable of gripping the cord in a first position spaced apart from the cutting device 9 and driving it in the direction of the cutting device 9 on a predetermined course (arrow C) to position 29c. The length of that course is roughly equal to the distance separating the cutoff point from the laying point of the cord 3 on the support 1. The clamp 29 is then opened and brought back to the standby position next to the rollers 20 and 21. In that case, the usefulness of the device constituted by the rollers 20 and 21 can be summed up in effective control of winding of the cord 3 (no drive function).

The invention thus makes possible rapid cutting of a reinforcement, whatever the constituent material. It allows for high rates of cord laying, for it proposes means of cutting comprising two elements that can on demand be brought close to each other in order to cut the cord, by appreciably displacing them parallel to the movement of the cord, so as to render the relative speed in the direction of feed of the cord between said elements and the cord as low as possible, at least at the time of cutting. As a result, there is no interruption nor even any slowdown of the cord due to cutting. This offers the tire designer wide freedom of design of reinforcements, for it is known that, if he chooses to lay several sections for each tire, manufacturing time is in no case impaired by multiplication of the number of cuts to be made.

In light of this description, the person of skill in the art may easily produce variants and use adaptations without departing from the scope of this invention.

I claim:

1. A tire reinforcement feed and cutting device, comprising:
a distributor for guiding a reinforcement;
a cutting device including a knife mounted on the periphery of a first rotary disk and a second rotary disk mounted opposite the first rotary disk; and
means for bringing the knife of the first disk and the second disk in contact with the reinforcement by rotation of the disks, the cutting device being preset so that, on cutting, the knife is actuated to engage with said reinforcement when the peripheral speed of the first and second rotary disks is close to the linear speed of the reinforcement.

2. A device according to claim 1, including means for imparting a predetermined advance motion to the reinforcement, after a cut, in the longitudinal direction of the movement of reinforcement.

3. A device according to claim 1, in which the distributor and the cutting device are adapted for guiding and cutting a reinforcement consisting of a single cord.

4. A device according to claim 1, including means of application for receiving the reinforcement below the cutoff point and channeling it to a reinforcement laying point on a manufacturing support.

5. A device according to claim 4, in which the means of application includes an application roller to press the reinforcement against the support.

6. A device according to claim 1, in which the second disk carries an anvil which cooperates with the knife of the first disk.

7. A device according to claim 6, in which the second disk has a radial cutout extended by a circumferential cutout which extends behind the anvil.

8. A method of manufacture of a tire reinforcement, comprising the following steps:
presenting a reinforcement laying head opposite a predetermined starting point on a fabrication support and advancing a cut end of said reinforcement to adhere to the support at the starting point;
driving the support in rotation in order to wind the reinforcement on the support, while synchronizing the relative displacement of the laying head on the support in order to sweep the surface of the support which is to be covered by the reinforcement; and
actuating cutting means for cutting the reinforcement without stopping the advance of the reinforcement, at a given time, so that the continuation of rotation of the support brings a trailing end of the reinforcement to a predetermined stopping point.

9. A method according to claim 8, in which the cutting means comprise two elements that on demand are brought close to each other in order to cut the reinforcement, by displacing the cutting means parallel to the movement of the reinforcement, so as to render the relative speed in the direction of feed of the reinforcement between the elements as low as possible, at least at the time of cutting.
